(19) United States
(12) Patent Application Publication
(10) Pub. No.: US 2025/0325932 A1
(43) Pub. Date: Oct. 23, 2025

(54) PREFILTRATION STRUCTURE FOR FILTER ELEMENT AND AIR PURIFIER

(71) Applicant: Shenzhen Beibanqiu Network Technology Co., Ltd., Shenzhen (CN)

(72) Inventors: Jin LI, Shenzhen (CN); Zhihai TANG, Shenzhen (CN); Weiwei XU, Shenzhen (CN)

(73) Assignee: Shenzhen Beibanqiu Network Technology Co., Ltd., Shenzhen (CN)

(21) Appl. No.: 19/257,411

(22) Filed: Jul. 1, 2025

(30) Foreign Application Priority Data
Jun. 11, 2025 (CN) 202521203614.X

(51) Int. Cl. B01D 46/681; B01D 46/00; B01D 46/18; B01D 46/22; B01D 46/62

(52) U.S. Cl. CPC B01D 46/681; B01D 46/0047; B01D 46/185; B01D 46/22; B01D 46/62; B01D 2273/30

(57) ABSTRACT

The present invention discloses a prefiltration structure for filter element and an air purifier, comprising: a first transmission belt, a second transmission belt, a first transmission gear, a prefiltration belt having opposing windward and leeward portions, and a driving member. The prefiltration belt is arranged at a side of a filter element to pre-filter the air entering the filter element, thereby reducing the frequency of cleaning or replacement of the filter element. When impurities are accumulated on the windward portion of the prefiltration belt, the driving member outputs power to drive the first transmission belt and the second transmission belt to rotate synchronously, thereby driving the prefiltration belt to rotate simultaneously. Meanwhile, a scraping member scrapes off the impurities accumulated on a surface of the prefiltration belt into an accommodation chamber, so that the prefiltration belt is cleaned.

### RELATED APPLICATIONS

The present patent document claims the benefit of priority to patent application No. 202521203614.X, filed Jun. 11, 2025, and entitled “PREFILTRATION STRUCTURE FOR FILTER ELEMENT AND AIR PURIFIER,” the entire contents of each of which are incorporated herein by reference.

### BACKGROUND

### 1. Technical Field

The present invention relates to the technical field of air purifiers, and particularly relates to a prefiltration structure for filter element and an air purifier.

### 2. Background Information

An air purifier is a device capable of improving indoor air quality. By means of filtration, the air purifier can effectively remove visible contaminants in the air to provide fresh and healthy air for people, which helps alleviate allergic symptoms, prevents respiratory diseases, and protects human health. Especially in places with serious air pollution or special environmental requirements, the air purifier play a vital role.

A surface of a filter element of the existing air purifier is prone to adsorb pet hair and dust, among which the pet hair is prone to clog air inlets on the surface of the filter element, reducing the filtration capacity of the air purifier. Users need to frequently clean the pet hair on the surface of the filter element, or replace the filter element. As a result, the user experience needs to be further improved.

### BRIEF SUMMARY

In order to overcome the shortcomings of the existing technology, the present invention provides a prefiltration structure for filter element and an air purifier.

The technical solution adopted by the present invention to solve its technical problems is as follows:

A prefiltration structure for filter element, comprising:
a first transmission belt;
a second transmission belt, which is arranged parallel to the first transmission belt;
a first transmission gear, which is drivingly connected to both the first transmission belt and the second transmission belt;
a driving member, whose output end is drivingly connected to the first transmission gear;
a prefiltration belt, whose two edges are fixed to the first transmission belt and the second transmission belt, respectively; wherein the prefiltration belt has opposing windward and leeward portions, the leeward portion is arranged adjacent to the filter element, the driving member outputs power and drives the first transmission gear to rotate, thereby driving the first transmission belt, the second transmission belt and the prefiltration belt to rotate synchronously;
a scraping member, which is fixedly arranged on the windward portion or the leeward portion of the prefiltration belt; as the prefiltration belt rotates, the scraping member is configured to scrape off the impurities of the prefiltration belt; and
an accommodation chamber, which is located at a bottom of the prefiltration belt to collect the impurities scraped off by the scraping member.

The prefiltration structure for filter element as described above, the accommodation chamber has no contact with the filter element at their adjacent side, and has at least one contact line at a side distal from the filter element.

The prefiltration structure for filter element as described above, the scraping member is fixed to a side of the accommodation chamber distal from the filter element, the scraping member is shaped to match an arc surface of the prefiltration belt, and the scraping member is in close contact with the bottom of the prefiltration belt.

The prefiltration structure for filter element as described above, a fabric brush is provided on a surface of the scraping member facing the prefiltration belt, and the fabric brush is configured to scrap off the hair attached to a surface of the prefiltration belt.

The prefiltration structure for filter element as described above, a first fixing plate is provided on a side of the first transmission belt distal from the second transmission belt, and a second fixing plate is provided on a side of the second transmission belt distal from the first transmission belt; the first fixing plate is configured to fix a position of the first transmission belt, and the second fixing plate is configured to fix a position of the second transmission belt.

The prefiltration structure for filter element as described above, it further comprises a first rotation shaft and a second rotation shaft, wherein the prefiltration belt is sleeved outside the first rotation shaft and the second rotation shaft, both ends of the first rotation shaft and the second rotation shaft are rotatably connected to the first fixing plate and the second fixing plate, respectively; the first transmission gear is fixed to an end of the first rotation shaft, a second transmission gear is fixed to an end of the first rotation shaft distal from the first transmission gear, and the second transmission gear is drivingly connected to the second transmission belt.

The prefiltration structure for filter element as described above, it comprises a primary transmission gear connected to an output end of the driving member, the driving member is located at a side of the filter element opposite to the prefiltration belt, and a secondary transmission gear is drivingly connected between the primary transmission gear and the first transmission gear.

The prefiltration structure for filter element as described above, a roll diameter of the first rotation shaft is larger than an addendum circle diameter of the second transmission gear and the first transmission gear, the first rotation shaft and the first fixing plate jointly restrict a rotation path of the first transmission belt, and the second rotation shaft and the second fixing plate jointly restrict a rotation path of the second transmission belt.

The prefiltration structure for filter element as described above, the second rotation shaft has the same structure as the first rotation shaft.

An air purifier, comprising:
a housing;
at least one air inlet arranged on the housing;
at least one air outlet arranged on the housing;
at least one fan arranged between any one of the air inlets and any one of the air outs;
at least one filter element arranged between any one of the air inlets and any one of the fans; and
at least one prefiltration structure for filter element arranged between any one of the air inlets and any one of the filter elements to pre-filter the air entering the filter element.

The beneficial effects of the present invention are as follows: the prefiltration belt is arranged at a side of a filter element to pre-filter the air entering the filter element, thereby reducing the frequency of cleaning or replacement of the filter element. When impurities are accumulated on the windward portion of the prefiltration belt, the driving member outputs power to drive the first transmission belt and the second transmission belt to rotate synchronously, thereby driving the prefiltration belt to rotate simultaneously. Meanwhile, the scraping member scrapes off the impurities accumulated on the surface of the prefiltration belt into the accommodation chamber, so that the prefiltration belt is cleaned.

### BRIEF DESCRIPTION OF THE DRAWINGS

The present invention is further illustrated below with reference to the drawings and embodiments.

FIG. 1 is a three-dimensional structural view of an air purifier in this embodiment.

FIG. 2 is a cross-sectional view of the air purifier in this embodiment.

FIG. 3 is an enlarged view of Part A in FIG. 2.

FIG. 4 is partial structural schematic view of a prefiltration structure for filter element.

FIG. 5 is an exploded view of the prefiltration structure for filter element.

### The Reference Numerals are as Follows:

first transmission belt 1, first fixing plate 11, second transmission belt 2, second fixing plate 21, first transmission gear 31, driving member 32, output end 32a of driving member32, second transmission gear 33, primary transmission gear 34, secondary transmission gear 35, prefiltration belt 4, windward portion 41, leeward portion 42, scraping member 61, accommodation chamber 62, fabric brush 63, contact line 63a, first rotation shaft 71, second rotation shaft 72;
housing 100, air inlet 101, air outlet 102, fan 103, prefiltration structure for filter element 104, filter element5.

### DETAILED DESCRIPTION OF THE DRAWINGS AND THE PRESENTLY PREFERRED EMBODIMENTS

The conception, specific structure, and technical effects of the present invention will be clearly and completely illustrated below in conjunction with embodiments and accompanying drawings, so as to fully understand the objectives, features, and advantages of the present invention. Apparently, the described embodiments are merely a part of the embodiments of the present invention, but not all of the embodiments. Based on the embodiments of the present invention, all other embodiments obtained by those of ordinary skill in the art without exerting creative efforts shall fall within the protection scope of the present invention. Additionally, all connection or coupling relationships involved in the patent do not mean that components are directly connected, but that a better connection structure can be formed by adding or reducing the connection accessories according to the specific embodiments. Each technical feature in the creation of the present invention can be combined interactively without conflicting with each other.

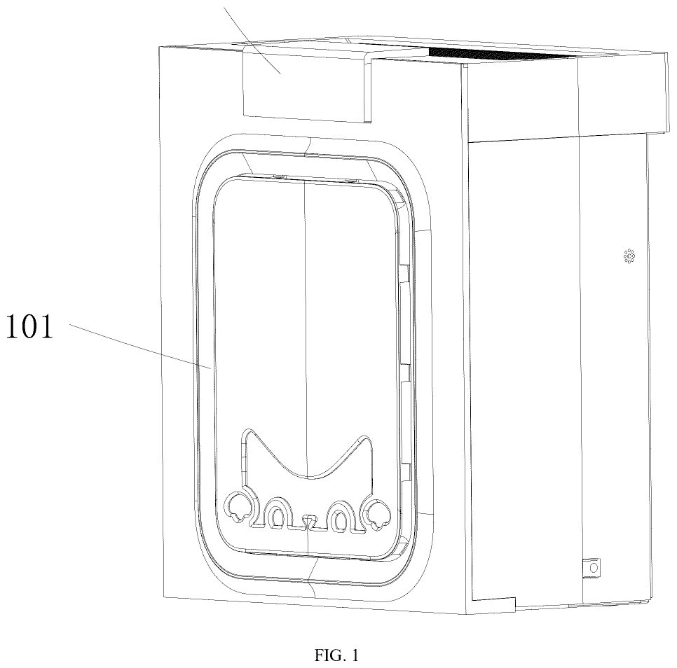

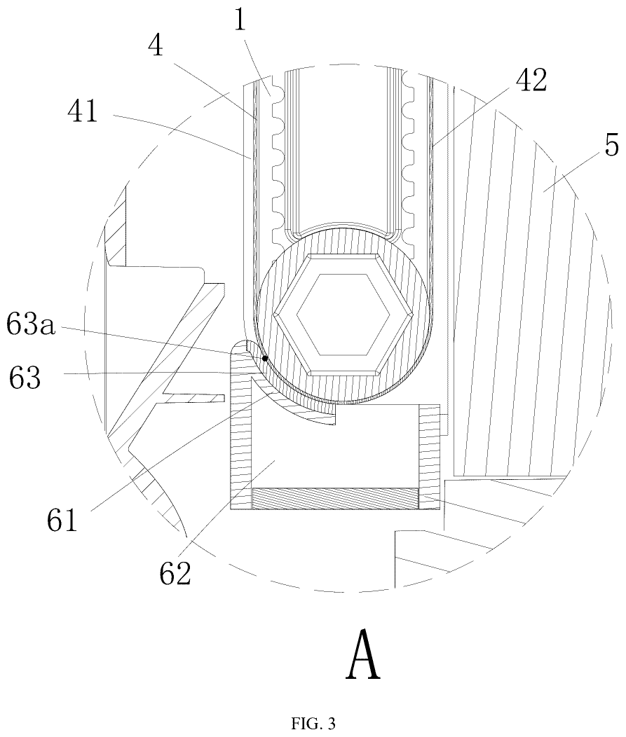

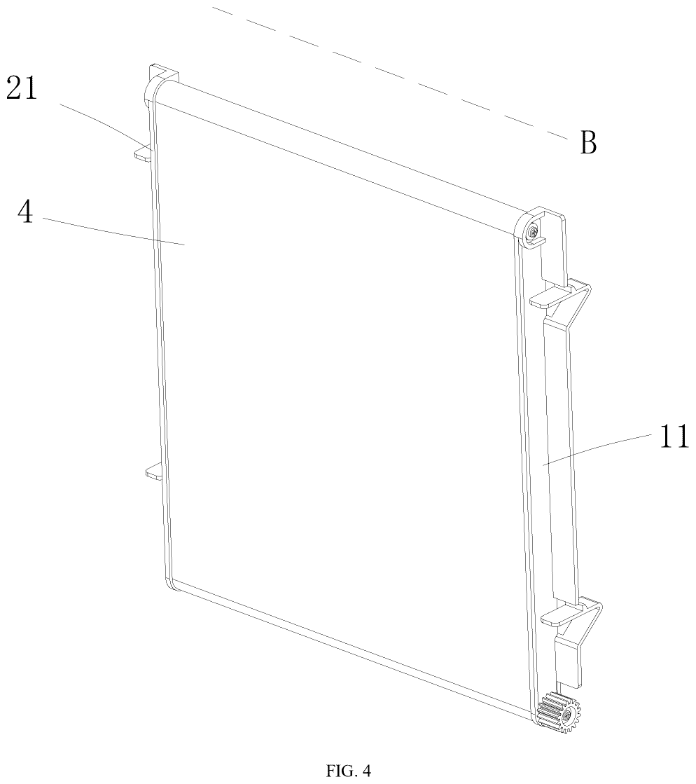

Referring to FIGS. 1-5, a prefiltration structure for filter element comprises: a first transmission belt 1; a second transmission belt 2, which is arranged parallel to the first transmission belt 1; a first transmission gear 31, which is drivingly connected to both the first transmission belt 1 and the second transmission belt 2; a driving member 32, whose output end 32a is drivingly connected to the first transmission gear 31; a prefiltration belt 4, whose two edges are fixed to the first transmission belt 1 and the second transmission belt 2, respectively; wherein the prefiltration belt 4 has opposing windward portion 41 and leeward portion 42, the leeward portion 42 is arranged adjacent to the filter element 5; the driving member 32 outputs power to drive the first transmission gear 31 to rotate, thereby driving the first transmission belt 1, the second transmission belt 2 and the prefiltration belt 4 to rotate synchronously; a scraping member 61, which is fixedly connected to either the windward portion 41 or the leeward portion 42 of the prefiltration belt 4; as the prefiltration belt 4 rotates, the scraping member 61 is configured to scrape off the impurities of the prefiltration belt 4; and an accommodation chamber 62, which is located at a bottom of the prefiltration belt 4 to collect the impurities scraped off by the scraping member 61.

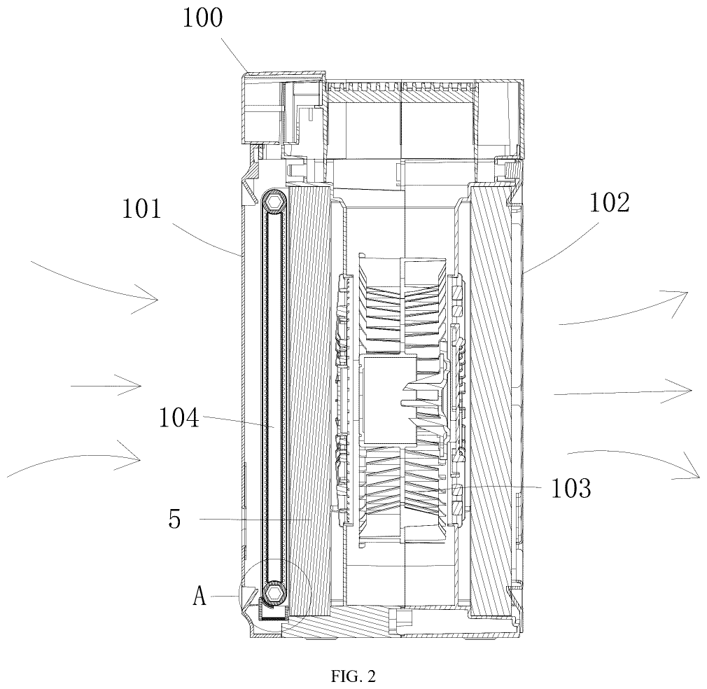

The prefiltration belt 4 is provided on a side of the filter element 5 to pre-filter the air entering the filter element 5 (The arrow in FIG. 2 indicates the direction of airflow.) thereby reducing the frequency of cleaning or replacement of the filter element 5. When impurities are accumulated on the windward portion 41 of the prefiltration belt 4, the driving member 32 outputs power to drive the first transmission belt 1 and the second transmission belt 2 to rotate synchronously, thereby driving the prefiltration belt 4 to rotate simultaneously. Meanwhile, the scraping member 61 scrapes off the impurities accumulated on the surface of the prefiltration belt 4 into the accommodation chamber 62, so that the prefiltration belt 4 is cleaned.

Specifically, the rotation shaft of the prefiltration belt 4 is defined as a first horizontal line B. Along the first horizontal line B, the lengths of both the scraper 61 and the accommodation chamber 62 are longer than the width of the prefiltration belt 4, which ensures that the scraping member 61 can completely scrap off the impurities on the prefiltration belt 4, and the impurities scraped from the prefiltration belt 4 can all fall into the accommodation chamber 62.

In one embodiment, the accommodation chamber 62 has no contact with the filter element 5 at their adjacent side, and has at least one contact line 63a at a side distal from the filter element 5. Compared to a point contact between the accommodation chamber 62 and the prefiltration belt 4, the line contact configuration can ensure that the impurities at the prefiltration belt 4 can be completely scraped off, thereby improving scraping efficiency.

Specifically, the contact line 63a is parallel to the rotation shaft of the prefiltration belt 4.

It should be understood that, if the accommodation chamber 62 is in surface contact with the filter element 5, it means that there are several contact lines between the accommodation chamber 62 and the filter 5.

In one embodiment, the scraping member 61 is fixed to a side of the accommodation chamber 62 distal from the filter element 5, the scraping member 61 is shaped to match an arc surface of the prefiltration belt 4, and the scraping member 61 is in close contact with the bottom of the prefiltration belt 4.

It should be understood that the scraping member 61 is in surface contact with the prefiltration belt 4, and the way of surface contact allows the scraping member 61 to more fully fit the scraping member 61, so the friction between the scraping member 61 and the prefiltration belt 4 is increased, which is helpful to loosen and remove the dust and dirt attached to the surface of the prefiltration belt 4.

In one embodiment, a fabric brush 63 is provided on a side of the scraping member 61 facing the prefiltration belt 4, and the fabric brush 63 is configured to scrap off the hair attached to the surface of the prefiltration belt 4.

It should be understood that, the prefiltration belt 4 has a filtering function, and its surface is covered with numerous micropores. The brushing of the fabric brush 63 is soft and has a certain elasticity, which can penetrate into various micropores, improving the cleaning effect of the prefiltration belt 4.

In one embodiment, a first fixing plate 11 is provided on a side of the first transmission belt 1 distal from the second transmission belt 2, and a second fixing plate 21 is provided on a side of the second transmission belt 2 distal from the first transmission belt 1. The first fixing plate 11 is configured to fix a position of the first transmission belt 1, and the second fixing plate 21 is configured to fix a position of the second transmission belt 2, thereby preventing the prefiltration belt 4 from disengaging from the first transmission belt 1 and the second transmission belt 2 during rotation process, which could affect the prefiltration effect.

In one embodiment, it further comprises a first rotation shaft 71 and a second rotation shaft 72. The prefiltration belt 4 is sleeved outside the first rotation shaft 71 and the second rotation shaft 72, both ends of the first rotation shaft 71 and the second rotation shaft 72 are rotatably connected to the first fixing plate 11 and the second fixing plate 21, respectively. The first transmission gear 31 is fixed to an end of the first rotation shaft 71, a second transmission gear 33 is fixed to an end of the first rotation shaft 71 distal from the first transmission gear 31, and the second transmission gear 33 is drivingly connected to the second transmission belt 2.

The first rotation shaft 71 and the second rotation shaft 72 serve as a structure for supporting the prefiltration belt 4, and transmit the power from the driving member 32 to the second transmission gear 33 through the first rotation shaft 71, thereby driving the first transmission belt 1 and second transmission belt 2 to rotate synchronously.

In one embodiment, it further comprises a primary transmission gear 34 connected to an output end 32a of the driving member 32, the driving member 32 is located on a side of the filter element 5 opposite to the prefiltration belt 4, and a secondary transmission gear 35 is drivingly connected between the primary transmission gear 34 and the first transmission gear 31.

The driving member 32 is located on the side opposite to the prefiltration belt 4, rather than being arranged at edge positions of the prefiltration belt 4, and the power outputted by the driving member 32 is transmitted through the secondary transmission gear 35. This design helps to reduce the overall volume of the filter element pre-filtration structure, thus to reduce the floor space.

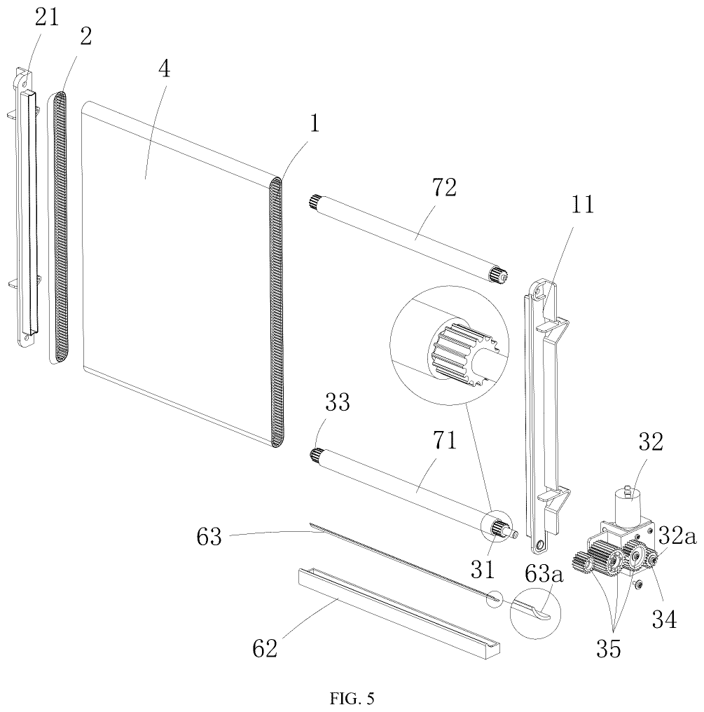

Referring to FIG. 5, in one embodiment, a roll diameter of the first rotation shaft 71 is larger than an addendum circle diameter of the second transmission gear 33 and the first transmission gear 31, the first rotation shaft 71 and the first fixing plate 11 jointly restrict a rotation path of the first transmission belt 1, and the second rotation shaft 72 and the second fixing plate 21 jointly restrict a rotation path of the second transmission belt 2. This ensures that the relative positions among the first fixing plate 11, the first rotation shaft 71, the second fixing plate 21, the second transmission gear 33, and the first transmission gear 31 remain stable, preventing the pre-filtration belt 4 from deviating when the driving member 32 drives the pre-filtration belt 4 to rotate, which affects the pre-filtration efficiency. Additionally, this avoids changes in the relative position between the scraping member 61 and the pre-filtration belt 4, ensuring the efficiency of impurity removal.

In one embodiment, the second rotational shaft 72 has the same structure as the first rotational shaft 71.

Referring to FIG. 2, an air purifier comprises: a housing 100; at least one air inlet 101 arranged on the housing 100; at least one air outlet102 arranged on the housing 100; at least one fan 103 arranged between any one of the air inlets 101 and any one of the air outs 103; at least one filter element 5 arranged between any one of the air inlets 101 and any one of the fans 103; and at least one prefiltration structure for filter element 104 arranged between any one of the air inlets 101 and any one of the filter elements 5 for prefiltering the air entering the filter element 5.

Specifically, the air purifier is provided with two air inlets 101 and one air outlet 102. Correspondingly, the two air inlets 101 are respectively provided with a prefiltration structure for filter element 104, and one side of each prefiltration structure for filter element 104 is provided with a filter element 5.

Specifically, the air purifier is provided with one air inlet 101 and one air outlet 102. The air inlet 101, the prefiltration structure for filter element 104, the filter element 5, the fan 103, and the air outlet 102 are arranged in sequence along a flow direction of the air.

The above provides detailed descriptions of preferred embodiments of the present invention. However, the scope of the present invention is not limited to the described embodiments. Those skilled in the art can make various equivalent modifications or substitutions without departing from the spirits of the present invention, and all such equivalent modifications or substitutions shall fall within the scope defined by the claims of the present invention.

1. A prefiltration structure for filter element, comprising:
a first transmission belt;
a second transmission belt, which is arranged parallel to the first transmission belt;
a first transmission gear, which is drivingly connected to both the first transmission belt and the second transmission belt;
a driving member, whose output end is drivingly connected to the first transmission gear;
a prefiltration belt, whose two edges are fixed to the first transmission belt and the second transmission belt, respectively; wherein the prefiltration belt has a windward portion and a leeward portion being opposite to each other, the leeward portion is arranged adjacent to the filter element, the driving member outputs power to drive the first transmission gear to rotate, thereby driving the first transmission belt, the second transmission belt and the prefiltration belt to rotate synchronously;
a scraping member, which is fixedly arranged above or on the windward portion or the leeward portion of the prefiltration belt; the scraping member is configured to scrape off impurities on the prefiltration belt as the prefiltration belt rotates; and
an accommodation chamber, which is located at a bottom of the prefiltration belt to collect the impurities scraped off by the scraping member.

2. The prefiltration structure according to claim 1, wherein the accommodation chamber has no contact with the filter element at their adjacent side, and has at least one contact line at a side distal from the filter element.

3. The prefiltration structure according to claim 2, wherein the scraping member is fixed at a side of the accommodation chamber distal from the filter element, the scraping member is shaped to match an arc surface of the prefiltration belt, and the scraping member is in close contact with the bottom of the prefiltration belt.

4. The prefiltration structure according to claim 3, wherein a fabric brush is provided on a surface of the scraping member facing the prefiltration belt, and the fabric brush is configured to scrap off hair attached on the prefiltration belt.

5. The prefiltration structure according to claim 1, wherein a first fixing plate is provided on a side of the first transmission belt distal from the second transmission belt, and a second fixing plate is provided on a side of the second transmission belt distal from the first transmission belt; the first fixing plate is configured to fix the first transmission belt, and the second fixing plate is configured to fix the second transmission belt.

6. The prefiltration structure according to claim 5, further comprising a first rotation shaft and a second rotation shaft, wherein the prefiltration belt is sleeved outside the first rotation shaft and the second rotation shaft, two ends of the first rotation shaft and the second rotation shaft are rotatably connected to the first fixing plate and the second fixing plate, respectively; the first transmission gear is fixed to an end of the first rotation shaft, a second transmission gear is fixed to another end of the first rotation shaft distal from the first transmission gear, and the second transmission gear is drivingly connected to the second transmission belt.

7. The prefiltration structure according to claim 1, wherein a primary transmission gear is connected to an output end of the driving member, the driving member is located on a side of the filter element opposite to the prefiltration belt, and at least a secondary transmission gear is drivingly connected between the primary transmission gear and the first transmission gear.

8. The prefiltration structure according to claim 6, wherein a roll diameter of the first rotation shaft is larger than an addendum circle diameter of the second transmission gear and the first transmission gear, the first rotation shaft and the first fixing plate jointly restrict a rotation path of the first transmission belt, and the second rotation shaft and the second fixing plate jointly restrict a rotation path of the second transmission belt.

9. The prefiltration structure according to claim 6, wherein the second rotation shaft has the same structure as the first rotation shaft.

10. An air purifier, comprising:
a housing;
at least one air inlet arranged on the housing;
at least one air outlet arranged on the housing;
at least one fan arranged between any one of the air inlets and any one of the air outlets;
at least one filter element arranged between any one of the air inlets and any one of the fans; and
at least one prefiltration structure for filter element according to claim 1 arranged between any one of the air inlets and any one of the filter elements to pre-filter air entering the filter element.
